(19) United States
(12) Patent Application Publication
(10) Pub. No.: US 2023/0228275 A1
(43) Pub. Date: Jul. 20, 2023

(54) SEALING SYSTEM FOR MAGNETIC LEVITATING CENTRIFUGAL COMPRESSOR AND MAGNETIC LEVITATING CENTRIFUGAL COMPRESSOR

(71) Applicant: Carrier Corporation, Palm Beach Gardens, FL (US)

(72) Inventors: Jiedong Li, Shanghai (CN); Vishnu Sishtla, Palm Beach Gardens, FL (US)

(21) Appl. No.: 18/153,789

(22) Filed: Jan. 12, 2023

(30) Foreign Application Priority Data
Jan. 17, 2022 (CN) 202210047178.6

(51) Int. Cl. F04D 29/10; F04D 25/06; F04D 17/10; F04D 29/058

(52) U.S. Cl. CPC F04D 29/102; F04D 25/06; F04D 17/10; F04D 29/058

(57) ABSTRACT

A sealing system for a magnetic levitating centrifugal compressor, the magnetic levitating centrifugal compressor including a motor cavity and a motor shaft disposed within the motor cavity, an end of the motor shaft extends out from the motor cavity and is mounted with an impeller, the sealing system includes: a seal which is sleeved on the outer side of the motor shaft and is disposed between the impeller and the motor cavity; a first magnet which is fixed at the outer surface of the motor shaft; and a second magnet which is fixed at a side of the seal facing the motor shaft; the first magnet and the second magnet form a radial repulsive force in the radial direction of the motor shaft, so that the seal can be levitated in relative to the motor shaft and move therewith.

### FOREIGN PRIORITY

This application claims priority to Chinese Patent Application No. 202210047178.6, filed Jan. 17, 2022, and all the benefits accruing therefrom under 35 U.S.C. § 119, the contents of which in its entirety are herein incorporated by reference.

### TECHNICAL FIELD OF INVENTION

The present invention relates to the field of refrigeration technology, in particular to a sealing system for magnetic levitating centrifugal compressor, further to a magnetic levitating centrifugal compressor provided with said sealing system, and to a refrigeration system configured with said magnetic levitating centrifugal compressor.

### BACKGROUND OF THE INVENTION

Currently, centrifugal compressors gradually adopt oil-free lubrication technology to replace the former oil circuit lubrication, thus eliminating the management of the lubricating oil system, such as oil circuit maintenance, oil return management and maintenance of the oil circuit system. On the other hand, oil-free lubrication also represents higher operating efficiency of compressor and higher operating efficiency of refrigeration system, lower vibration and noise, stable operation and much lower cost, cleaner and better customer experience.

Magnetic levitating bearings are an important way and means to solve the problem of oil-free lubrication of centrifugal compressors. Centrifugal compressor supported by magnetic levitating bearings consists of shell, volute, impeller, magnetic levitating bearings and high-speed motor and other parts. In the working process, the high-speed motor is supported by the magnetic levitating bearings at the left and right ends, with low rotary resistance and high rotational speed. In this type of bearing mechanism, there is often a touchdown bearing, which is designed to prevent the damage of the magnetic levitating bearing part resulted from the collision of the magnetic levitating bearings with the motor shaft when the magnetic levitating bearings fail. Therefore, the radial clearance between the touchdown bearing and the motor shaft is typically smaller than the radial clearance between the magnetic levitating bearings and the motor shaft, for example, the radial clearance between the touchdown bearing and the motor shaft is half of the radial clearance between the magnetic levitating bearings and the motor shaft. In addition, in order to prevent airflow from the impeller side entering into the motor cavity, a seal is provided between the impeller and the motor cavity, said seal is typically a fixed labyrinth seal structure with teeth and fixed to the shell of the motor cavity. In order to avoid tooth damage due to collision between said motor shaft and said seal, the radial clearance between said seal and said motor shaft is designed to be relatively large, generally more than twice the touchdown bearing clearance, thus the sealing effect of said seal is relatively poor, and the amount of gas leaking from the impeller side is high, resulting in lower efficiency of the magnetic levitating centrifugal compressor.

### SUMMARY OF THE INVENTION

In view of this, according to a first aspect of the present invention, it provides a sealing system for magnetic levitating centrifugal compressor, thereby effectively solving the above-mentioned problems and the problems of other aspects that exist in the prior art. Said magnetic levitating centrifugal compressor comprises a motor cavity and a motor shaft disposed within said motor cavity, an end of said motor shaft extends out from said motor cavity and is mounted with an impeller. In the sealing system for magnetic levitating centrifugal compressor according to the present invention, said sealing system comprises: a seal, said seal is sleeved on the outer side of said motor shaft and is disposed between said impeller and said motor cavity, for reducing the flow of fluid from said impeller to said motor cavity; a first magnet, said first magnet is fixed at an outer surface of said motor shaft; and a second magnet, said second magnet is fixed at a side of said seal facing said motor shaft, wherein said first magnet and said second magnet form a radial repulsive force in the radial direction of said motor shaft, so that said seal can be levitated in relative to said motor shaft.

In a further embodiment of the sealing system according to the present invention, a tension spring is provided on top of said seal for resisting the gravity of said seal, one end of said tension spring rests against said seal and the other end of said tension spring rests against a housing, said housing is fixedly connected to the shell of said motor cavity.

In another embodiment of the sealing system according to the present invention, a compression spring is provided at the bottom of said seal for resisting the gravity of said seal, one end of said compression spring rests against said seal and the other end of said compression spring rests against a housing, said housing is fixedly connected to the shell of said motor cavity.

In a further embodiment of the sealing system according to the present invention, there are a plurality of said first magnets and a plurality of said second magnets, wherein the plurality of said first magnets are arranged at an outer surface of said motor shaft at equal intervals along the radial direction of said motor shaft, and the plurality of said second magnets are arranged at equal intervals on a side of said seal facing said motor shaft.

In a further embodiment of the sealing system according to the present invention, said motor shaft is provided with a sleeve, and said first magnets are fixed to said sleeve in an inserted manner.

In another embodiment of the sealing system according to the present invention, the plurality of said first magnets are fixed at the outer surface of said motor shaft by means of a carbon fiber tape in a winding manner.

In a further embodiment of the sealing system according to the present invention, said sealing system further comprises an anti-rotation pin, said anti-rotation pin is inserted between said seal and said housing for preventing said seal from rotating relative to said housing.

In a further embodiment of the sealing system according to the present invention, there are a plurality of said anti-rotation pins, and the plurality of said anti-rotation pins are arranged at equal intervals in the circumferential direction of said seal.

In a further embodiment of the sealing system according to the present invention, a side of said seal fits against said housing, the fitting surfaces between said seal and said housing are provided with a wear resistant coating.

In yet another embodiment of the sealing system according to the present invention, said first magnet and said second magnet are radially magnetizing permanent magnets; or that said first magnet and said second magnet are axially magnetizing permanent magnets.

Furthermore, according to a second aspect of the present invention, it also provides a magnetic levitating centrifugal compressor, said magnetic levitating centrifugal compressor is provided with a sealing system as described above.

Furthermore, according to a third aspect of the present invention, it also provides a refrigeration system, said refrigeration system is configured with a magnetic levitating centrifugal compressor as described above.

Further, according to a fourth aspect of the present invention, it also provides a sealing system for magnetic levitating centrifugal compressor, said magnetic levitating centrifugal compressor comprises a motor cavity and a motor shaft disposed within said motor cavity, said motor shaft has a first end and a second end extending out from said motor cavity, said first end of said motor shaft is mounted with a first impeller, said second end of said motor shaft is mounted with a second impeller, said sealing system comprises: a first seal, said first seal is sleeved on the outer side of said motor shaft and is disposed between said first impeller and said motor cavity, for reducing the flow of fluid from said first impeller to said motor cavity; a second seal, said second seal is sleeved on the outer side of said motor shaft and is disposed between said second impeller and motor cavity, for reducing the flow of fluid from said second impeller to said motor cavity; a first magnet assembly, said first magnet assembly comprises a first magnet and a second magnet, said first magnet is fixed at an outer surface of said motor shaft and said second magnet is fixed at a side of said first seal facing said motor shaft; and a second magnet assembly, said second magnet assembly comprises a third magnet and a fourth magnet, said third magnet is fixed at an outer surface of said motor shaft and said fourth magnet is fixed at a side of said second seal facing said motor shaft, wherein said first magnet and said second magnet form a repulsive force in the radial direction of said motor shaft to keep said first seal and said motor shaft in a concentric levitation, and wherein said third magnet and said fourth magnet form a repulsive force in the radial direction of said motor shaft to keep said second seal and said motor shaft in a concentric levitation.

Furthermore, according to a fifth aspect of the present invention, it also provides a magnetic levitating centrifugal compressor, said magnetic levitating centrifugal compressor is provided with the sealing system as described above.

Furthermore, according to a sixth aspect of the present invention, it also provides a refrigeration system, said refrigeration system is configured with a magnetic levitating centrifugal compressor as described above.

It can be understood that the sealing system for magnetic levitating centrifugal compressor of the present invention is of a follow-up construction, using mutually repulsive magnetic forces to enable the seal to be levitated in relative to the motor shaft. As a result, the radial clearance between the seal of said sealing system and the motor shaft can be designed to be as small as possible without the use of additional tooling or special designs, further reducing the gas leakage from the impeller side.

### BRIEF DESCRIPTION OF THE DRAWINGS

The technical solution of the present invention will be described in further detail hereinafter in connection with the accompanying drawings and embodiments, wherein:

FIG. 1 illustrates a schematic cross-sectional view of a sealing system for magnetic levitating centrifugal compressor according to an embodiment of the present invention;

FIG. 2 illustrates a schematic longitudinal sectional view of the sealing system for magnetic levitating centrifugal compressor of FIG. 1;

FIG. 3 illustrates a schematic cross-sectional view of the sealing system for magnetic levitating centrifugal compressor of FIG. 1 with the motor shaft falling onto the touchdown bearing; and

FIG. 4 illustrates a schematic cross-sectional view of a sealing system for magnetic levitating centrifugal compressor according to an embodiment of the present invention in the case of using an axially magnetizing permanent magnet.

### DETAILED DESCRIPTION OF THE INVENTION

Several embodiments of the present invention will be described in detail below in connection with the accompanying drawings. It should be noted that the orientation terms such as up, down, left, right, front, back, inside, outside, top, bottom, etc., mentioned or may mentioned in this description are defined relative to the construction shown in each of the accompanying drawings, and they are relative concepts, and therefore may change accordingly depending on the different location and different state of use in which they are located. Therefore, these or other orientation terms should not be interpreted as restrictive terms.

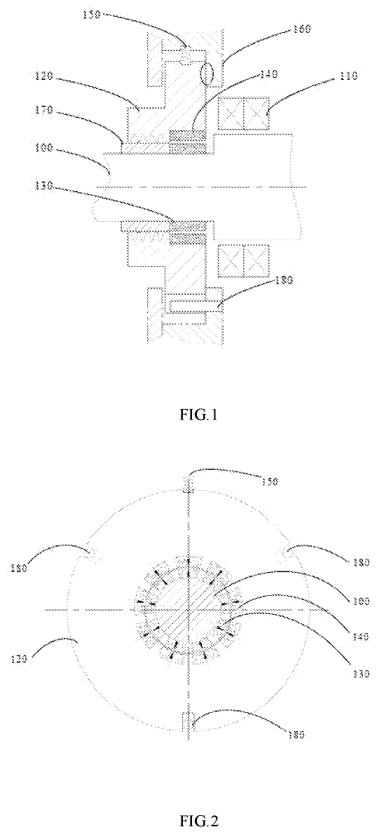

As shown in FIG. 1, it illustrates schematically in general terms the structure of one embodiment of the sealing system for magnetic levitating centrifugal compressor of the present invention. Said magnetic levitating centrifugal compressor includes a motor cavity (not shown) and a motor shaft 100, said motor shaft 100 is located within said motor cavity and supported in rotation by a magnetic levitating bearing assembly, an end of said motor shaft 100 extends out from said motor cavity and is mounted with an impeller (not shown) and a touchdown bearing 110. Said magnetic levitating bearing assembly may include: a radial magnetic levitating bearing (not shown), an axially magnetic levitating bearing (not shown). There is a radial clearance between said touchdown bearing 110 and the motor shaft 100, the radial clearance is smaller than the radial clearance between the stator portion and the rotor stack of said radial magnetic levitating bearing (the rotor stack of said radial magnetic levitating bearing is fixedly mounted on the outer side of the motor shaft), thus avoiding collision between the rotor stack and the stator portion of said radial magnetic levitating bearing in the event of a stoppage or a sudden power failure of said magnetic levitating centrifugal compressor. Said touchdown bearing 110 may be in the form of a ball bearing. As can be clearly seen from FIGS. 1 and 2, said sealing system comprises: a seal 120, a first magnet 130 and a second magnet 140. The seal 120, for example in the form of a labyrinth seal structure with teeth, is sleeved on the outer side of said motor shaft 100 and is disposed between said impeller and said motor cavity so as to reduce the flow of fluid from said impeller to said motor cavity. In general, there is a radial clearance between said seal 120 and the motor shaft 100, said radial clearance is greater than the radial clearance existing between said touchdown bearing 110 and the motor shaft 100, so as to prevent tooth damage of the labyrinth seal structure due to collision of said seal with the motor shaft in case of stoppage or sudden power failure of said magnetic levitating centrifugal compressor.

In the above embodiment of the sealing system for magnetic levitating centrifugal compressor according to the present invention, said first magnet 130 is fixed at the outer surface of said motor shaft 100. Said second magnet 140 is fixed at a side of said seal 120 facing said motor shaft 100. Said first magnet 130 and said second magnet 140 form a radial repulsive force in the radial direction of said motor shaft 100 (as shown by the arrow in FIG. 2), e.g., the magnetic poles of the opposite sides of said first magnet 130 and said second magnet 140 are the same, enabling said seal 120 to be “levitated” on said motor shaft 100, thus preventing said seal 120, and in particular its toothed structure, from colliding with said motor shaft 100. The “levitated” here refers to a state in which the seal 120 maintains a relatively stable interval with respect to the motor shaft 100. Preferably, the seal 120 and the motor shaft 100 maintain a concentric interval. Since said seal 120 is designed in a follow-up structure, i.e. said seal 120 can be levitated up and down with said motor shaft 100, the radial clearance between said seal and said motor shaft may be designed to be as small as possible, so as to further reduce the gas leakage from the back side of said impeller near said motor cavity.

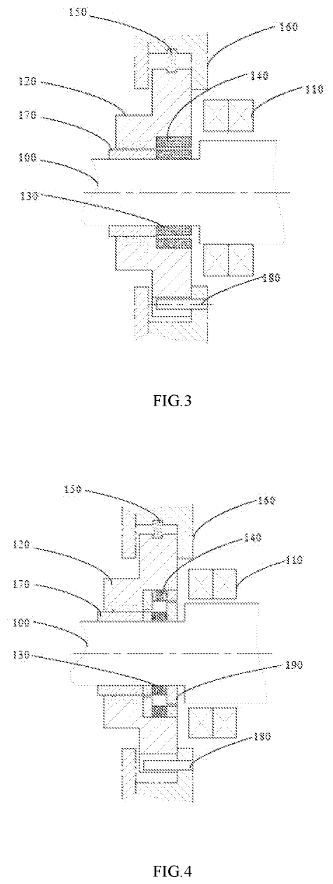

When said magnetic levitating centrifugal compressor is in normal operation, said motor shaft 100 is levitated and running at high speed, while said seal 120 remains concentrically arranged with said motor shaft 100 under the action of radial repulsive force, as shown in FIG. 1. When said magnetic levitating centrifugal compressor stops working or when there is a sudden power failure, said motor shaft 100 falls due to gravity and comes into contact with said touchdown bearing 110, as shown in FIG. 3. At this time, said seal 120 falls with said motor shaft 100 under the mutual repulsive force of said first magnet 130 and said second magnet 140, at which time the radial clearance between said seal 120 and said housing 160 at the top becomes larger and the radial clearance between said seal 120 and housing 160 at the bottom becomes smaller, while no contact occurs between said seal 120 and said motor shaft 100.

In order to be able to partially or even fully counteract the gravity of said seal 120 so as to keep said seal 120 and said motor shaft 100 as concentric as possible under the action of the repulsive force of the magnets, an extension spring 150 is provided at the top of said seal 120, one end of said extension spring 150 rests against said seal 120 and the other end of said extension spring 150 rests against the housing 160, said housing 160 is fixedly connected to the shell (not shown) of said motor cavity. Alternatively, a compression spring is provided at the bottom of said seal, one end of said compression spring rests against said seal and the other end of said compression spring rests against said housing, said housing is fixedly connected to the shell of said motor cavity.

In conjunction with the above embodiment, in other preferred embodiments, there are a plurality of said first magnet 130 and said second magnet 140, wherein the plurality of said first magnets 130 are arranged at an outer surface of said motor shaft 100 at equal intervals along the radial direction of said motor shaft 100, and the plurality of said second magnets 140 are arranged at equal intervals on a side of said seal 120 facing said motor shaft 100, as shown in FIG. 2. Further, said motor shaft 100 is provided with a sleeve 170, said sleeve 170 is for example tightly fitted to said motor shaft 100, said first magnet 130 is fixed to said sleeve 170 in an inserted manner, thereby preventing said first magnets from flying out due to centrifugal force when the motor shaft is rotating. As an alternative, said plurality of first magnets are fixed at the outer surface of said motor shaft by means of carbon fiber tape in a winding manner.

With continued reference to FIG. 2, said sealing system further comprises an anti-rotation pin 180, said anti-rotation pin 180 is inserted between said seal 120 and said housing 160 to prevent said seal 120 from rotating relative to said housing 160, i.e. said seal 120 can only be levitated up and down with said motor shaft 100. Further, there are a plurality of said anti-rotation pins 180 and said plurality of anti-rotation pins 180 are arranged at equal intervals in the circumferential direction of said seal 120.

It will be readily understood by those skilled in the art that typically the volute cavity in which said impeller is located is a high pressure area and said motor cavity is a low pressure area, so that the pressure on the side of said seal 120 near said impeller is always greater than the pressure on the side of said seal 120 near said motor cavity, causing friction due to the side of said seal 120 (on the right in the figure) abutting against said housing 160, as shown in the circled portion of FIG. 1. Thus, the wear-resistant coating may be provided on the fitting surfaces between said seal 120 and said housing 160. On the other hand, due to the friction, said seal will not be levitated when said motor shaft moves slightly, but only be moved with the motor shaft when the radial movement of the motor shaft exceeds a certain value, i.e. when the repulsive force on said seal exceeds the frictional force, and the certain value of radial movement must not exceed the sealing gap between said seal and said motor shaft surface.

As an example, said first magnet 130 and said second magnet 140 are radially magnetizing permanent magnets, as shown in FIGS. 1 and 3. By this time, the direction of the repulsive force between the first magnet 130 and the second magnet 140 is along the radial direction of the motor shaft 100. As an alternative, said first magnet 130 and said second magnet 140 are axially magnetizing permanent magnets, as shown in FIG. 4. By this time, the direction of the repulsive force between the first magnet 130 and the second magnet 140 is along the axial direction of the motor shaft 100. In order to enable the seal 120 to levitate relative to the motor shaft 100, the repulsive force in the axial direction needs to be converted into a repulsive force in the radial direction by the magnetic conductive ring 190 made of magnetic conductive metal. Compared with the radially magnetizing permanent magnet, the axially magnetizing permanent magnet has a simpler manufacturing process and lower cost.

The present invention also proposes a sealing system for magnetic levitating centrifugal compressor. Said magnetic levitating centrifugal compressor may be of a back-to-back two-stage compression design. Specifically, said magnetic levitating centrifugal compressor may comprise a motor cavity and a motor shaft located in said motor cavity, a first impeller and a second impeller, wherein said first impeller constitutes a low pressure stage of compression and said second impeller constitutes a high pressure stage of compression, said second impeller, i.e., the impeller of the second stage being typically smaller than said first impeller, i.e., the impeller of the first stage, wherein the inlet of the impeller of the second stage is the outlet of the impeller of the first stage. Said motor shaft is located in said motor cavity and is supported by a magnetic levitating bearing assembly during rotation. Said motor shaft has a first end and a second end extending out from said motor cavity. Said first end of said motor shaft is mounted with a first impeller and a first touchdown bearing, and said second end of said motor shaft is mounted with a second impeller and a second touchdown bearing.

In the above embodiment of back-to-back two-stage compression, both of the first end and the second end of the motor shaft are provided with the sealing construction as shown in FIG. 1,3 or 4. Specifically, said sealing system comprises: a first seal, a second seal, a first magnet assembly, and a second magnet assembly. Said first seal is sleeved on the outer side of said motor shaft 100 and is located between said first impeller and said motor cavity, thereby reducing the flow of fluid from said first impeller to said motor cavity. Said second seal is sleeved on the outside of said motor shaft and is located between said second impeller and said motor cavity, thereby reducing the flow of fluid from said second impeller to said motor cavity. Said first magnet assembly includes a first magnet 130 and a second magnet 140, said first magnet 130 is fixed at the outer surface of said motor shaft 100 and said second magnet 140 is fixed at a side of said first seal facing said motor shaft 100. Said second magnet assembly includes a third magnet and a fourth magnet, said third magnet is fixed at the outer surface of said motor shaft and said fourth magnet is fixed at a side of said second seal facing said motor shaft. Said first magnet and said second magnet form a repulsive force in the radial direction of said motor shaft and keep said first seal and said motor shaft in a concentric levitation, and said third magnet and said fourth magnet form a repulsive force in the radial direction of said motor shaft and keep said second seal and said motor shaft in a concentric levitation.

In summary, the sealing system for magnetic levitating centrifugal compressor of the present invention is of a follow-up type construction, using the radial repulsive force between the magnets to keep the seal and the motor shaft in a concentric arrangement and to enable said seal to be levitated on said motor shaft. In this way, the radial clearance between the seal and the motor shaft becomes as small as possible without the use of additional tooling or special designs, and the gas leakage from the back side of said impeller near said motor cavity is further reduced.

In addition, the present invention provides a magnetic levitating centrifugal compressor, which is provided with a sealing system as described according to various embodiments. In addition, the present invention provides a refrigeration system configured with said magnetic levitating centrifugal compressor, said refrigeration system may comprise a cooling tower, a cooling water unit and a pumping unit, etc. connected by piping, wherein said cooling water unit comprises a magnetic levitating centrifugal compressor, a condenser, a throttling device and an evaporator, etc. As pointed out in the above, by providing the above-mentioned magnetic levitating centrifugal compressor, the air tightness can be effectively improved without additional manufacturing cost, thus the efficiency of the magnetic levitating centrifugal compressor is further improved, and therefore it is recommended herein to use the above-mentioned magnetic levitating centrifugal compressor in all kinds of refrigeration systems.

The specific embodiments described above are intended only to describe more clearly the principle of the present invention, which is made easier to understand by clearly illustrating or describing the individual components. Without departing from the scope of the present invention, the person skilled in the art may easily make various modifications or variations to the present invention. Therefore, it should be understood that these modifications or variations should be included within the scope of patent protection of the present invention.

What is claimed is:

1. A sealing system for magnetic levitating centrifugal compressor, said magnetic levitating centrifugal compressor comprises a motor cavity and a motor shaft disposed within said motor cavity, an end of said motor shaft extends out from said motor cavity and is mounted with an impeller, characterized in that, said sealing system comprises:
a seal, said seal is sleeved on the outer side of said motor shaft and is disposed between said impeller and said motor cavity, for reducing the flow of fluid from said impeller to said motor cavity;
a first magnet, said first magnet is fixed at an outer surface of said motor shaft; and
a second magnet, said second magnet is fixed at a side of said seal facing said motor shaft,
wherein said first magnet and said second magnet form a radial repulsive force in the radial direction of said motor shaft, so that said seal can be levitated in relative to said motor shaft.

2. The sealing system according to claim 1, characterized in that, a tension spring is provided on top of said seal for resisting the gravity of said seal, one end of said tension spring rests against said seal and the other end of said tension spring rests against a housing, said housing is fixedly connected to the shell of said motor cavity.

3. The sealing system according to claim 1, characterized in that, a compression spring is provided at the bottom of said seal for resisting the gravity of said seal, one end of said compression spring rests against said seal and the other end of said compression spring rests against a housing, said housing is fixedly connected to the shell of said motor cavity.

4. The sealing system according to claim 2, characterized in that, there are a plurality of said first magnets and a plurality of said second magnets, wherein the plurality of said first magnets are arranged at an outer surface of said motor shaft at equal intervals along the radial direction of said motor shaft, and the plurality of said second magnets are arranged at equal intervals on a side of said seal facing said motor shaft.

5. The sealing system according to claim 4, characterized in that, said motor shaft is provided with a sleeve, and said first magnets are fixed to said sleeve in an inserted manner.

6. The sealing system according to claim 4, characterized in that, the plurality of said first magnets are fixed at the outer surface of said motor shaft by means of a carbon fiber tape in a winding manner.

7. The sealing system according to claim 2, characterized in that, said sealing system further comprises an anti-rotation pin, said anti-rotation pin is inserted between said seal and said housing for preventing said seal from rotating relative to said housing.

8. The sealing system according to claim 7, characterized in that, there are a plurality of said anti-rotation pins, and the plurality of said anti-rotation pins are arranged at equal intervals in the circumferential direction of said seal.

9. The sealing system according to claim 2, characterized in that, a side of said seal fits against said housing, the fitting surfaces between said seal and said housing are provided with a wear resistant coating.

10. The sealing system according to claim 2, characterized in that, said first magnet and said second magnet are radially magnetizing permanent magnets; or that said first magnet and said second magnet are axially magnetizing permanent magnets.

11. A magnetic levitating centrifugal compressor, characterized in that, said magnetic levitating centrifugal compressor is provided with the sealing system according to claim 1.

12. A refrigeration system, characterized in that, said refrigeration system is configured with the magnetic levitating centrifugal compressor according to claim 11.

13. A sealing system for magnetic levitating centrifugal compressor, said magnetic levitating centrifugal compressor comprises a motor cavity and a motor shaft disposed within said motor cavity, said motor shaft has a first end and a second end extending out from said motor cavity, said first end of said motor shaft is mounted with a first impeller, said second end of said motor shaft is mounted with a second impeller, characterized in that, said sealing system comprises:
a first seal, said first seal is sleeved on the outer side of said motor shaft and is disposed between said first impeller and said motor cavity, for reducing the flow of fluid from said first impeller to said motor cavity;
a second seal, said second seal is sleeved on the outer side of said motor shaft and is disposed between said second impeller and said motor cavity, for reducing the flow of fluid from said second impeller to said motor cavity;
a first magnet assembly, said first magnet assembly comprises a first magnet and a second magnet, said first magnet is fixed at an outer surface of said motor shaft and said second magnet is fixed at a side of said first seal facing said motor shaft; and
a second magnet assembly, said second magnet assembly comprises a third magnet and a fourth magnet, said third magnet is fixed at an outer surface of said motor shaft and said fourth magnet is fixed at a side of said second seal facing said motor shaft,
wherein said first magnet and said second magnet form a repulsive force in a radial direction of said motor shaft to keep said first seal and said motor shaft in a concentric levitation, and wherein said third magnet and said fourth magnet form a repulsive force in a radial direction of said motor shaft to keep said second seal and said motor shaft in a concentric levitation.

14. A magnetic levitating centrifugal compressor, characterized in that, said magnetic levitating centrifugal compressor is provided with the sealing system according to claim 13.

15. A refrigeration system, characterized in that, said refrigeration system is configured with the magnetic levitating centrifugal compressor according to claim 14.
